(19) United States
(12) Patent Application Publication
(10) Pub. No.: US 2026/0333468 A1
(43) Pub. Date: Oct. 22, 2026

(54) COMPUTATION LOAD BALANCING AND ACCESS CONTROL

(71) Applicant: QUALCOMM Incorporated, San Diego, CA (US)

(72) Inventors: Navid ABEDINI, Basking Ridge, NJ (US); Hua WANG, Basking Ridge, NJ (US); Junyi LI, Greentown, PA (US); Tao LUO, San Diego, CA (US)

(21) Appl. No.: 19/642,445

(22) Filed: Apr. 8, 2026

Related U.S. Application Data
(60) Provisional application No. 63/790,913, filed on Apr. 18, 2025.

(51) Int. Cl. H04W 76/10; H04W 36/08; H04W 76/30

(52) U.S. Cl. CPC H04W 76/10; H04W 36/08; H04W 76/30

(57) ABSTRACT

Various aspects of the present disclosure generally relate to wireless communication. In some aspects, a user equipment (UE) may transmit, to a wireless communication device, a connection message to initiate a connection with the wireless communication device, wherein the connection is for requesting a computation service from the wireless communication device. The UE may communicate computation service management information with the wireless communication device, wherein the computation service management information is associated with a computation capacity of the wireless communication device. Numerous other aspects are described.

### CROSS-REFERENCE TO RELATED APPLICATION

This Patent Application claims priority to U.S. Provisional Patent Application No. 63/790,913, filed on Apr. 18, 2025, entitled “COMPUTATION LOAD BALANCING AND ACCESS CONTROL,” and assigned to the assignee hereof. The disclosure of the prior Application is considered part of and is incorporated by reference into this Patent Application.

### FIELD OF THE DISCLOSURE

Aspects of the present disclosure generally relate to communication and specifically relate to techniques, apparatuses, and methods associated with computation load balancing and access control.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

As described herein, in a network architecture that supports distributed compute services, computational tasks may be offloaded from a user equipment (UE) to utilize resources of other devices, such as network nodes, edge servers, or other UEs within the network. This approach leverages the processing power, memory capabilities, and storage distributed across the network to perform complex computations closer to the data source (e.g., rather than or in addition to relying on a central cloud server), reducing latency and improving performance for applications requiring real-time data processing. In a distributed compute service model, a UE may request computation services from a nearby network node, which may process the computation service request locally or may forward the computation service request to another device in the network with available processing resources. The processing results may be returned to the UE, either via the nearby network node or directly from the other device, which may support the efficient use of network resources and may enhance overall user experience. This model is particularly beneficial in scenarios where low latency and high computational power are critical, such as in augmented reality, autonomous driving, and other advanced applications.

In one example of a computation service, a network architecture that supports edge computing may use small, distributed local data centers to provide a resource-dense computational platform close to an originating device. In edge computing, devices and/or application clients may offload computing requests to an edge network device. Moreover, edge computing provides low latency access to high processing capabilities and data federation (e.g., aggregation of data from multiple different systems). This may be useful, for example, for IoT applications, data processing applications, and/or multimedia applications, among other examples. Accordingly, edge computing may serve a wide range of devices with on-demand applications.

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include one or more processors and one or more code-storing memories coupled with the one or more processors. The processing system may be configured to cause the UE to transmit, to a wireless communication device, a connection message to initiate a connection with the wireless communication device, wherein the connection is for requesting a computation service from the wireless communication device. The processing system may be configured to cause the UE to communicate computation service management information with the wireless communication device, wherein the computation service management information is associated with a computation capacity of the wireless communication device.

Some aspects described herein relate to a wireless communication device. The wireless communication device may include a processing system. The processing system may include one or more processors and one or more code-storing memories coupled with the one or more processors. The processing system may be configured to cause the wireless communication device to receive, from a UE, a connection request message that initiates a connection procedure with the UE, wherein the connection request message indicates that the connection request message is associated with a computation service request for a computation service from the wireless communication device. The processing system may be configured to cause the wireless communication device to communicate computation service management information with the UE, wherein the computation service management information is associated with a computation capacity of the wireless communication device.

Some aspects described herein relate to a method of wireless communication performed by a UE. The method may include transmitting, to a wireless communication device, a connection message to initiate a connection with the wireless communication device, wherein the connection is for requesting a computation service from the wireless communication device. The method may include communicating computation service management information with the wireless communication device, wherein the computation service management information is associated with a computation capacity of the wireless communication device.

Some aspects described herein relate to a method of wireless communication performed by a wireless communication device. The method may include receiving, from a UE, a connection request message that initiates a connection procedure with the UE, wherein the connection request message indicates that the connection request message is associated with a computation service request for a computation service from the wireless communication device. The method may include communicating computation service management information with the UE, wherein the computation service management information is associated with a computation capacity of the wireless communication device.

Some aspects described herein relate to a non-transitory computer-readable medium that stores a set of instructions for wireless communication by a UE. The set of instructions, when executed by one or more processors of the UE, may cause the UE to transmit, to a wireless communication device, a connection message to initiate a connection with the wireless communication device, wherein the connection is for requesting a computation service from the wireless communication device. The set of instructions, when executed by one or more processors of the UE, may cause the UE to communicate computation service management information with the wireless communication device, wherein the computation service management information is associated with a computation capacity of the wireless communication device.

Some aspects described herein relate to a non-transitory computer-readable medium that stores a set of instructions for wireless communication by a wireless communication device. The set of instructions, when executed by one or more processors of the wireless communication device, may cause the wireless communication device to receive, from a UE, a connection request message that initiates a connection procedure with the UE, wherein the connection request message indicates that the connection request message is associated with a computation service request for a computation service from the wireless communication device. The set of instructions, when executed by one or more processors of the wireless communication device, may cause the wireless communication device to communicate computation service management information with the UE, wherein the computation service management information is associated with a computation capacity of the wireless communication device.

Some aspects described herein relate to an apparatus for wireless communication. The apparatus may include means for transmitting, to a wireless communication device, a connection message to initiate a connection with the wireless communication device, wherein the connection is for requesting a computation service from the wireless communication device. The apparatus may include means for communicating computation service management information with the wireless communication device, wherein the computation service management information is associated with a computation capacity of the wireless communication device.

Some aspects described herein relate to an apparatus for wireless communication. The apparatus may include means for receiving, from a UE, a connection request message that initiates a connection procedure with the UE, wherein the connection request message indicates that the connection request message is associated with a computation service request for a computation service from a wireless communication device. The apparatus may include means for communicating computation service management information with the UE, wherein the computation service management information is associated with a computation capacity of the wireless communication device.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings, and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram of an example environment in which systems and/or methods described herein may be implemented.

FIG. 3 is a diagram illustrating an example of edge computing architecture, in accordance with the present disclosure.

FIG. 4 is a diagram of an example associated with computation load balancing and access control.

FIG. 5 is a diagram illustrating an example of computation load balancing and access control.

FIG. 6 is a diagram illustrating an example process performed, for example, at a user equipment (UE) or an apparatus of a UE.

FIG. 7 is a diagram illustrating an example process performed, for example, at a wireless communication device or an apparatus of a wireless communication device.

FIG. 8 is a diagram of an example apparatus for wireless communication.

FIG. 9 is a diagram of an example apparatus for wireless communication.

### DETAILED DESCRIPTION

As described herein, in a network architecture that supports distributed compute services, computational tasks may be offloaded from a user equipment (UE) to utilize resources of other devices, such as network nodes, edge servers, or other UEs within the network. This approach leverages the processing power, memory capabilities, and storage distributed across the network to perform complex computations closer to the data source (e.g., rather than or in addition to relying on a central cloud server), reducing latency and improving performance for applications requiring real-time data processing. In a distributed compute service model, a UE may request computation services from a nearby network node, which may process the computation service request locally or may forward the computation service request to another device in the network with available processing resources to complete the computational task. The request may include a request for the device to perform a computation to obtain processing results on behalf of the UE. The processing results may be returned to the UE, either via the nearby network node or directly from the other device, which may support the efficient use of network resources and may enhance overall user experience. This model is particularly beneficial in scenarios where low latency and high computational power are critical, such as in augmented reality, autonomous driving, and other advanced applications.

In some examples, the term “computation service” or “compute service” (sometimes referred to as “infrastructure as a service” (IaaS) or another term) may refer to a service that provides access to processing, memory, storage, or other suitable information technology resources to perform or execute one or more operations, such as data processing operations, image processing operations, edge computing operations, and/or other suitable operations.

An aspect of distributed computing includes edge computing, which uses small, distributed local data centers to provide a resource-dense computational platform close to an originating device, such as a UE. In edge computing, devices and/or application clients may offload computing requests to an edge network device. Moreover, edge computing provides low latency access to high processing capabilities and data federation (e.g., aggregation of data from multiple different systems). This may be useful, for example, for IoT applications, data processing applications, and/or multimedia applications, among other examples. Accordingly, edge computing may serve a wide range of devices with on-demand applications. Edge computing brings network services closer to a UE in order to supplement the capabilities of the UE, to decrease latency, and to enhance user services. Edge network devices may offload processing from the UE to help the UE to conserve power and to multi-task.

In wireless communication systems, the concept of distributed compute services has gained prominence, particularly in the context of anticipatory 6G features. These services are not only limited to large-scale infrastructure, such as cloud servers, but are increasingly expected to reside at the network edge, including locally at network nodes and UEs. The ability to offload computation from UEs to the network or another device may enhance system efficiency and create new revenue opportunities for network operators. The integration of computation services with radio access network (RAN) procedures may present challenges, particularly when considering the dynamic nature of network load and UE mobility.

Some wireless communication devices, such as a network node (e.g., a distributed unit (DU), a centralized unit (CU), or another network device), a UE (e.g., that is enabled for sidelink communications, or exchanging relayed communications with a UE via a network device), or an edge computing device, may host or offer computation services. For example, UEs that are connected to or camped on a network node may offer computation services and thus may act as server UEs to offload computational tasks from client UEs. The communications between client UEs and server UEs may either be direct or facilitated through the network node. In some examples, a client UE may select and attempt to connect to a cell or network node primarily to request and receive computation services from a wireless communication device. The wireless communication device may not be able to provide the service, for example, because it may be computationally overloaded, or for energy saving purposes, it may have limitations on offered services. For example, this could be due to computational overload or energy-saving measures that limit the offered services.

One consideration arises when a UE requests access to computation services, but lacks prior knowledge about computational load or resource availability of the requested device. For example, the requested device may have a limited amount of processing, memory, or storage for performing a requested computational task for another device due to device limitations, ongoing processing tasks, or energy-saving considerations. The device may not have available resources to accommodate the computation service request, and as a result, the UE may waste resources requesting services from a device that does not have available resources. Another consideration concerns UEs that are provided with information regarding network computational load and resource availability. This information may influence the UE decision-making regarding whether to connect to the wireless communication device or to request computation services from the wireless communication device. Further, the mobility of the UE may impact the efficiency of computation service provisioning. For example, if the UE initiates a computation service session with a network node but then moves out of the communication or computation coverage area, providing the requested service may not be efficient or even feasible for the network node. Consequently, there may be a need to consider UE mobility, such as a stationary or mobile state, speed, direction, and expected mobility duration, when deciding whether and how to admit the request for computation services.

Various aspects relate generally to enhancing the management of computation service requests within wireless communication systems, particularly in the context of RAN procedures and distributed compute services. For example, some aspects described herein include access and load control procedures that take specific considerations for managing computation load into account. Some aspects more specifically relate to a UE transmitting, and a wireless communication device (e.g., such as a network node, a CU, a DU, an edge computing device or server, another UE) receiving, a connection message to initiate a connection with the wireless communication device, wherein the connection is for requesting a computation service from the wireless communication device. For example, the connection message may indicate that the connection is only for requesting computation services, or is for requesting computation services and for enabling at least one other type of communication (e.g., any type of communication that can be performed after an access procedure). In some aspects, the wireless communication device and the UE may communicate computation service management information associated with the computation capacity of the wireless communication device.

In some aspects, the UE may receive an indication of available computation service resources in response to transmitting the connection message. This response may include estimates of wait times or indications of computational load or resource availability. Upon receiving this information, the UE may refrain from transmitting or proceeding with a computation service request due to insufficient resources (e.g., resources that are less than what is needed to fulfill the request or obtain a processing result that satisfies the request), may proceed with the computation service request based on sufficient resources (e.g., resources that are equal to or more than what is needed to fulfill the request), may cancel a connection procedure, or may wait to reattempt a connection procedure. In some aspects, when the indication indicates insufficient resources for the requested service, the UE may transmit a forward request to offload the computation service to another wireless communication device.

In other aspects, the computation service management information may include a connection release message that triggers the UE to transition to an idle or inactive state, with an estimate of a wait time provided before a subsequent connection attempt for requesting the computation service.

In some aspects, the UE and the wireless communication device may communicate mobility information of the UE. In such aspects, the computation service management information may indicate whether the wireless communication device accepts or denies a computation service request in accordance with the mobility information of the UE.

Particular aspects of the subject matter described in this disclosure may be implemented to realize one or more of the following potential technical advantages. By enabling the UE to effectively communicate computation service requests and manage responses, the described techniques may be used to optimize the use of computation resources within the network, potentially reducing unnecessary signaling and conserving network resources. Further, communication of the computation service management information may enable a wireless communication device to manage requests, thereby increasing the effective usage of available computation resources and potentially avoiding unnecessary overhead and resource usage. For example, by communicating the computation service management information, the wireless communication device may efficiently manage computation requests, whether by admitting, rejecting, forwarding, or instructing the UE to wait or reconnect later.

For example, by providing information (e.g., early information during a connection procedure) about the computation capacity of the wireless communication device, the UE may take the computation capacity information into account when requesting computation services, which may avoid transmitting requests when resources are unavailable, thereby conserving processing resources, memory resources, network resources, or the like. In some aspects, by considering the mobility (e.g., determining whether the wireless communication device can accommodate the mobility of the UE via paging, or handover, among other examples) of the UE when deciding whether to accept a computation service request, wireless communication devices may avoid the initiation of services for UEs that may soon move out of the communication or computation coverage area when that mobility cannot be accommodated, thus conserving network and computation resources by avoiding inefficient resource allocation. Additionally, by supporting the transfer of computation-related data to a UE via a new serving network node, services may be maintained without interruption during UE mobility.

Furthermore, the implementation of an access control mechanism for computation load balancing may decrease a likelihood that network nodes are overwhelmed by excessive computation demands, which may conserve processing resources and maintain stable network performance. By defining new access categories and IDs associated with computation services, UEs may be managed in a way that aligns with the computational capabilities of the network, ensuring that computation services are allocated and utilized more efficiently.

The described techniques and aspects for computation service management by a wireless communication device providing local computation services may support the efficient distribution and management of computation services within a network, thereby optimizing resource utilization and maintaining service quality.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

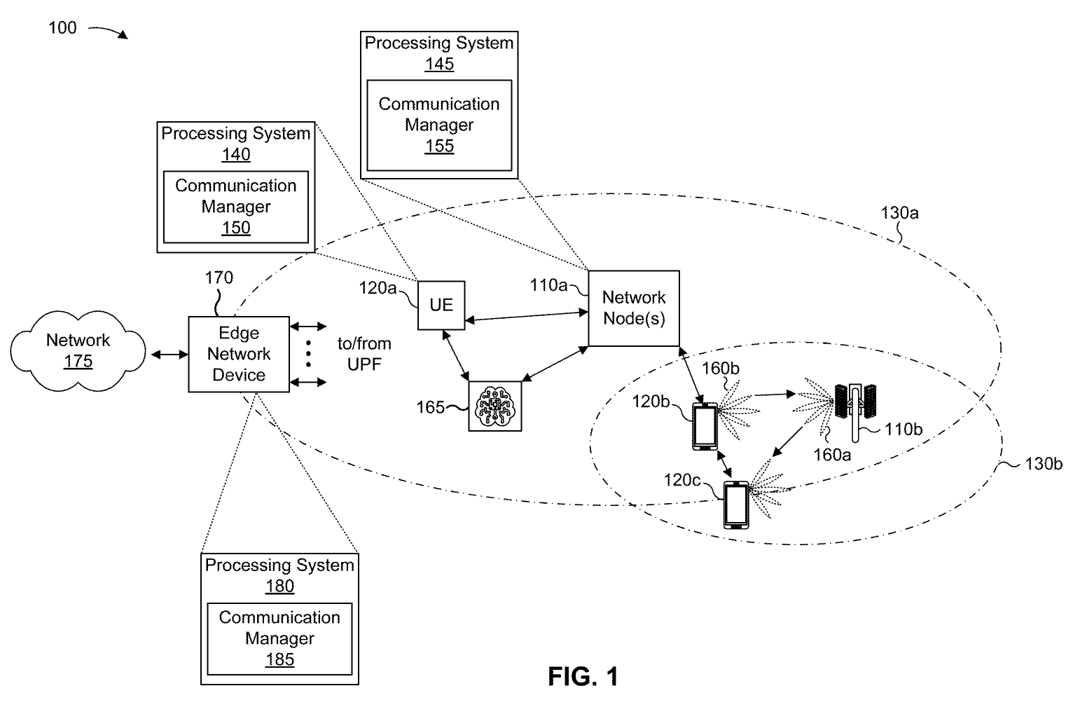

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110. The wireless communication network 100 may include an edge network device 170 of an edge network that supports edge computing services.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 or an edge network device 170 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145 and the edge network device 170 includes a processing system 180. A processing system (for example, the processing system 140, the processing system 145, or the processing system 180) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140, the processing system 145, or the processing system 180 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140, the processing system 145, or the processing system 180 may each include or be coupled with one or more modems (such as a cellular (for example, a 5G or 6G compliant) modem). In some examples, one or more processors of the processing system 140, the processing system 145, or the processing system 180 may include or implement one or more of the modems. The processing system 140, the processing system 145, or the processing system 180 also may include or be coupled with multiple radios (collectively “the radio”), multiple RF chains, or multiple transceivers, each of which may in turn be coupled with one or more of multiple antennas. In some examples, one or more processors of the processing system 140, the processing system 145, or the processing system 180 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140, the processing system 145, or the processing system 180).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a RAN. In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more CUs, one or more DUs, and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, UE 120 may communicate with the edge network device 170 of an edge network that supports edge computing services. Edge computing uses small, distributed local data centers to provide a resource-dense computational platform close to an originating device. In edge computing, devices and/or application clients may offload computing requests to an edge network device. Moreover, edge computing provides low latency access to high processing capabilities and data federation (e.g., aggregation of data from multiple different systems). This may be useful, for example, for IoT applications, data processing applications, and/or multimedia applications, among other examples. Accordingly, edge computing may serve a wide range of devices with on-demand applications. For example, edge network device 170 may offload processing from UE 120 to help the UE 120 to conserve power and use processing resources to perform other functions. UE 120 may communicate with edge network device 170 via network node 110 and/or a user plane function (UPF). Edge network device 170 may communicate with a network 175 which may be an example of a core network, a cloud computing network, or another type of network.

In some aspects, the UE 120 may include a communication manager 150. As described in more detail elsewhere herein, the communication manager 150 may transmit, to a wireless communication device (e.g., another UE 120, a network node 110, an edge network device 170, among other examples), a connection message to initiate a connection with the wireless communication device, wherein the connection is for requesting a computation service from the wireless communication device; and communicate computation service management information with the wireless communication device, wherein the computation service management information is associated with a computation capacity of the wireless communication device. Additionally, or alternatively, the communication manager 150 may perform one or more other operations described herein.

In some aspects, the wireless communication device may include the communication manager 150, a communication manager 155, or a communication manager 185. As described in more detail elsewhere herein, the communication manager 150, the communication manager 155, or the communication manager 185 may receive, from the UE 120, a connection request message that initiates a connection procedure with the UE 120, wherein the connection request message indicates that the connection request message is associated with a computation service request for a computation service from the wireless communication device; and communicate computation service management information with the UE 120, wherein the computation service management information is associated with a computation capacity of the wireless communication device. Additionally, or alternatively, the communication manager 150, the communication manager 155, or the communication manager 185 may perform one or more other operations described herein.

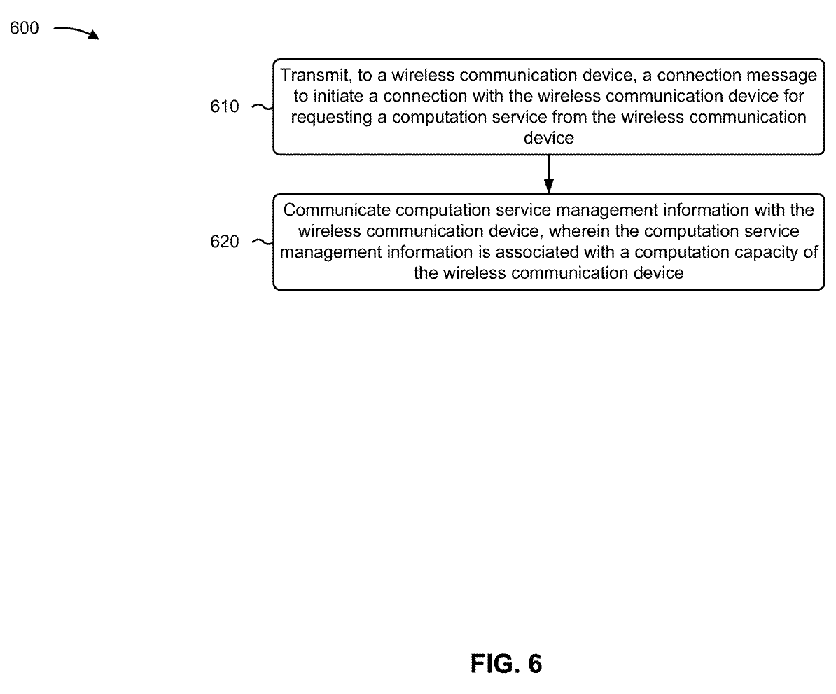

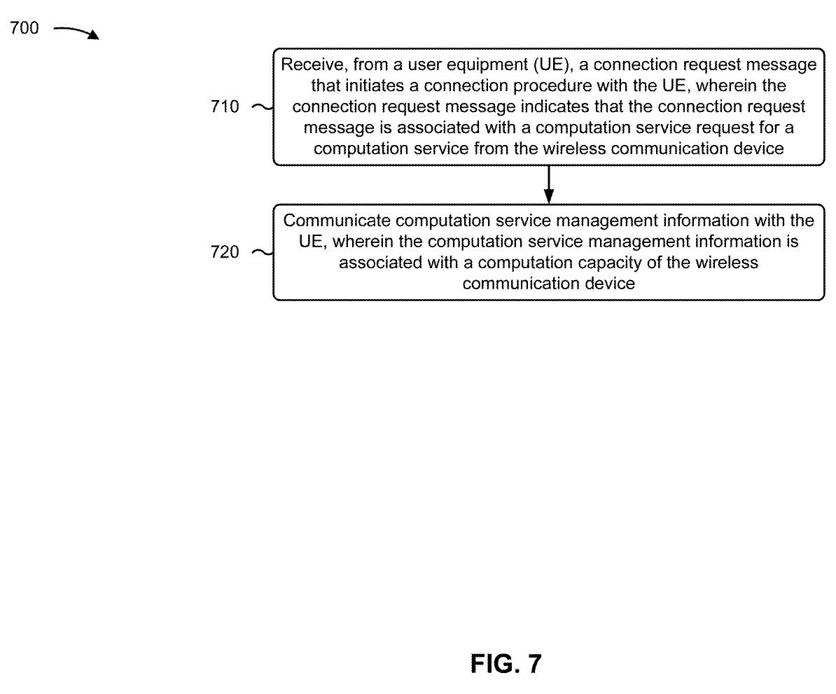

The network node 110, the processing system 145 of the network node 110, the UE 120, the processing system 140 of the UE 120, or any other component(s) of FIG. 1 may implement one or more techniques or perform one or more operations associated with computation load balancing and access control, as described in more detail elsewhere herein. For example, the processing system 145 of the network node 110, or the processing system 140 of the UE 120, or the processing system 180 of the edge network device 170 may perform or direct operations of, for example, process 600 of FIG. 6, process 700 of FIG. 7, or other processes as described herein (alone or in conjunction with one or more other processors). In some aspects, the wireless communication device described herein is the network node 110, is included in the network node 110, or includes one or more components of the network node 110 shown in FIG. 1. In some aspects, the wireless communication device described herein is the UE 120, is included in the UE 120, or includes one or more components of the UE 120 shown in FIG. 1. Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 140, the processing system 145, or the processing system 180) of the network node 110, or the UE 120, or the edge network device 170 may cause the one or more processors to perform process 600 of FIG. 6, process 700 of FIG. 7, or other processes as described herein. In some examples, executing instructions may include running the instructions, converting the instructions, compiling the instructions, or interpreting the instructions, among other examples.

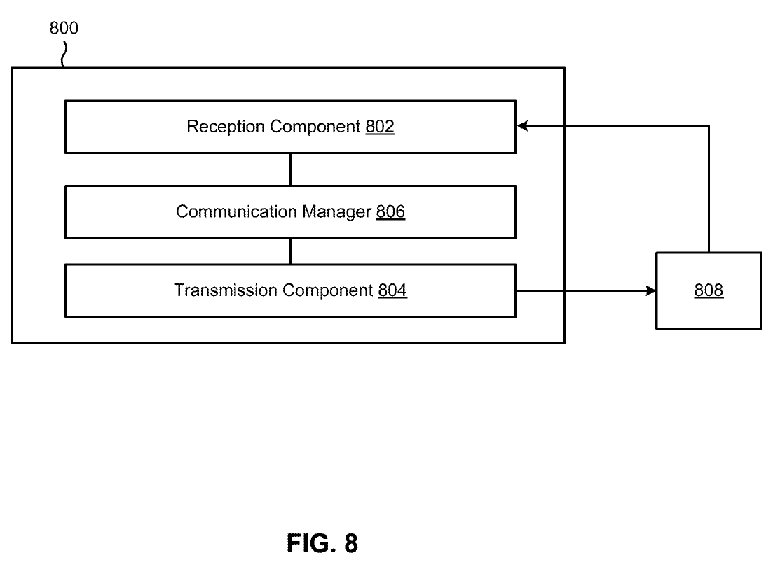

In some aspects, the UE 120 includes means for transmitting, to a wireless communication device (e.g., a network node 110, another UE 120, an edge network device 170, among other examples), a connection message to initiate a connection with the wireless communication device, wherein the connection is for requesting a computation service from the wireless communication device; or means for communicating computation service management information with the wireless communication device, wherein the computation service management information is associated with a computation capacity of the wireless communication device. The means for the UE 120 to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

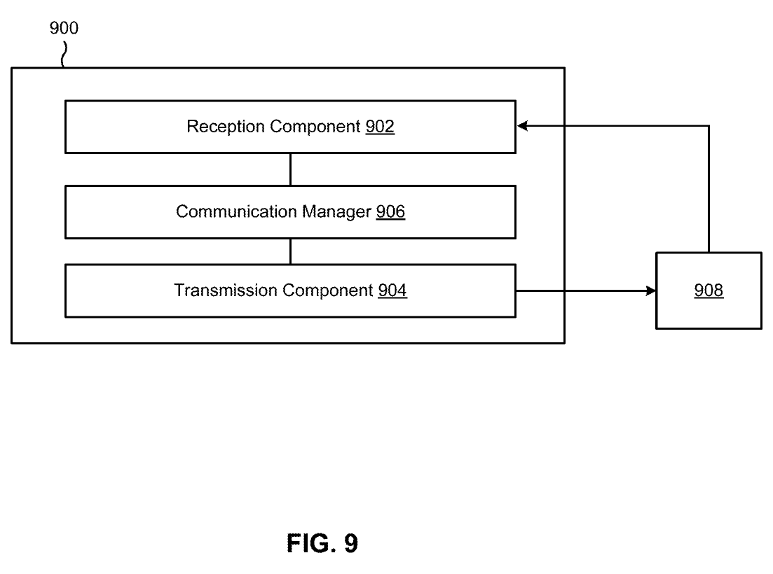

In some aspects, the wireless communication device (e.g., a network node 110, another UE 120, an edge network device 170, among other examples) includes means for receiving, from the UE 120, a connection request message that initiates a connection procedure with the UE 120, wherein the connection request message indicates that the connection request message is associated with a computation service request for a computation service from the wireless communication device; or means for communicating computation service management information with the UE 120, wherein the computation service management information is associated with a computation capacity of the wireless communication device. In some aspects, the means for the wireless communication device to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples. In some aspects, the means for the wireless communication device to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples. In some aspects, the means for the wireless communication device to perform operations described herein may include, for example, one or more of communication manager 185, processing system 180, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

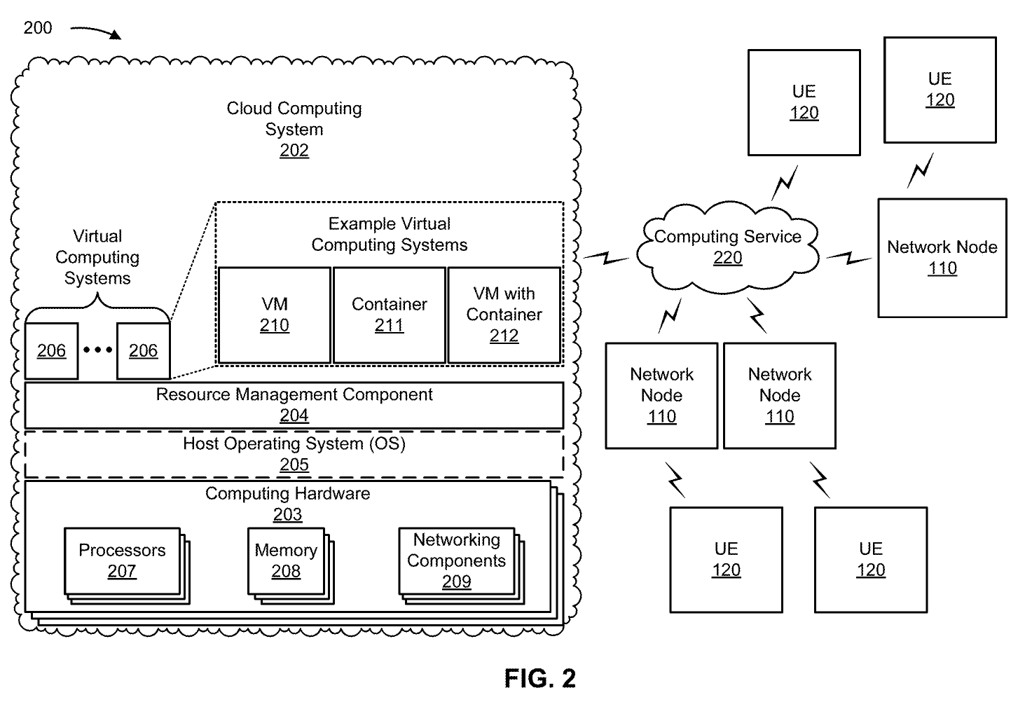

FIG. 2 is a diagram of an example environment 200 in which systems and/or methods described herein may be implemented. As shown in FIG. 2, the environment 200 may support aspects of a computation service, which may include one or more elements of and/or may execute in conjunction with a cloud computing system 202. The cloud computing system 202 may include one or more elements 203-212, as described in more detail below. As further shown in FIG. 2, environment 200 may include a computing service in communication with one or more UEs 120 and/or network nodes 110. Devices and/or elements of environment 200 may interconnect via wired connections and/or wireless connections.

The cloud computing system 202 may include computing hardware 203, a resource management component 204, a host operating system (OS) 205, and/or one or more virtual computing systems 206. The resource management component 204 may perform virtualization (e.g., abstraction) of computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from computing hardware 203 of the single computing device. In this way, computing hardware 203 may operate more efficiently, with lower power consumption, higher reliability, higher availability, higher utilization, greater flexibility, and lower cost than using separate computing devices.

The computing hardware 203 may include hardware and corresponding resources from one or more computing devices. For example, computing hardware 203 may include hardware from a single computing device (e.g., a single server) or from multiple computing devices (e.g., multiple servers), such as multiple computing devices in one or more data centers. As shown, computing hardware 203 may include one or more processors 207, one or more memories 208, and/or one or more networking components 209. Examples of a processor, a memory, and a networking component (e.g., a communication component) are described elsewhere herein.

The resource management component 204 may include a virtualization application (e.g., executing on hardware, such as computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 may include a virtual environment that enables cloud-based execution of operations and/or processes described herein using computing hardware 203. As shown, a virtual computing system 206 may include a virtual machine 210, a container 211, or a hybrid environment 212 that includes a virtual machine and a container, among other examples. A virtual computing system 206 may execute one or more applications using a file system that includes binary files, software libraries, and/or other resources required to execute applications on a guest operating system (e.g., within the virtual computing system 206) or the host operating system 205.

Although the example 200 may include one or more elements 203-212 of the cloud computing system 202, may execute within the cloud computing system 202, and/or may be hosted within the cloud computing system 202, in some implementations, the compute services may not be cloud-based (e.g., may be implemented outside of a cloud computing system) or may be partially cloud-based.

The network 220 may include one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

As described herein, in a network architecture that supports distributed compute services, computational tasks may be offloaded from a user equipment (UE) to utilize resources of other devices, such as network nodes, edge servers, or other UEs within the network. This approach leverages the processing power, memory capabilities, and storage distributed across the network to perform complex computations closer to the data source (e.g., rather than or in addition to relying on a central cloud server), reducing latency and improving performance for applications requiring real-time data processing. As described herein, in a network architecture that supports distributed compute services, computational tasks may be offloaded to, executed by, or coordinated across networked devices, edge nodes, or cloud infrastructure. These services enable efficient resource utilization, reduced latency, and enhanced performance for UE applications by distributing computational workloads beyond the UE 120. For example, in a distributed compute service model, a UE 120 may request computation services from a nearby network node 110 (or another device offering compute services, such as a UE 120 or an edge network device 170), which may process the computation service request locally or may forward the computation service request to another device in the network with available processing resources. The processing results may be returned to the UE 120, either via the nearby network node 110 or directly from the other device, which may support the efficient use of network resources and may enhance overall user experience. This model is particularly beneficial in scenarios where low latency and high computational power are critical, such as in augmented reality, autonomous driving, and other advanced applications.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

As indicated above, FIG. 2 is provided as an example. Other examples may differ from what is described with respect to FIG. 2.

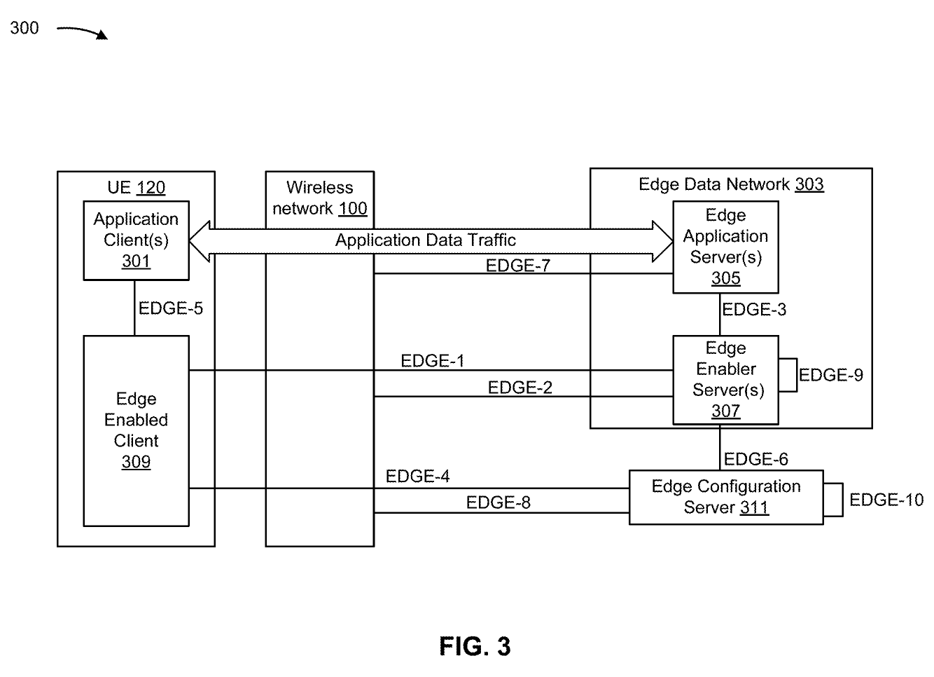

FIG. 3 is a diagram illustrating an example 300 of edge computing architecture, in accordance with the present disclosure. As shown in FIG. 3, example 300 includes a UE 120 communicating with a wireless communication network 100. The UE 120 may execute one or more applications (e.g., application client(s) 301) that are configured to use edge computing resources. By using the edge computing resources, the application client(s) experience reduced latency because the edge computing resources are deployed within, or adjacent to, a core network supporting the wireless communication network 100.

For example, as shown in FIG. 3, the edge computing resources may be provided from an edge data network (EDN) 303 and by one or more edge application servers 305 within the EDN 303. Additionally, the edge application servers may communicate with the wireless communication network 100 using an EDGE-7 interface.

The edge application server(s) 305 may provide the edge computing resources at the request of one or more edge enabler servers (EESs) 307. The EESs may communicate with each other using an EDGE-9 interface. Additionally, the EESs may communicate with the wireless communication network 100 using an EDGE-2 interface.

In order to request the edge computing resources, the application client(s) 301 may communicate with an edge enable client (EEC) 309 (e.g., executed by the UE 120) via an EDGE-5 interface. Accordingly, the EEC 309 may request the edge computing resources from the edge application server(s) 305 via the EES 307 (e.g., using an EDGE-1 interface).

The EEC 309 may contact one or more edge configuration servers 311 via an EDGE-4 interface to determine which EES 307 to use. The ECS(s) 311 may communicate with each other using an EDGE-10 interface. The ECS(s) 311 may store information associated with the EDNs available to the EEC 309 and may also provide authorization of the EEC 309 to the EES 307 via an EDGE-6 interface. The ECS(s) 311 may additionally communicate with the wireless communication network 100 using an EDGE-8 interface.

Edge computing uses small, distributed local data centers to provide a resource-dense computational platform close to an originating device. In edge computing, devices and/or application clients may offload computing requests to an edge network device. Moreover, edge computing provides low latency access to high processing capabilities and data federation (e.g., aggregation of data from multiple different systems). This may be useful, for example, for IoT applications, data processing applications, and/or multimedia applications, among other examples. Accordingly, edge computing may serve a wide range of devices with on-demand applications.

Edge computing brings network devices closer to the UE 120 in order to supplement the UE capabilities, UE capacity, and to enhance user services. Edge data network devices may offload processing of the UE 120 and help the UE 120 to conserve power and to multi-task. For example, when the UE 120 is using an application, an application context (e.g., a set of information relating to the application, such as information relating to application data, application customization, a present state of the application, or the like) is created where processing for the application occurs (point of compute), and the point of compute may be in an edge network device or on the UE 120. More specifically, the application context connected to the application may reside on an edge application server 305 of the edge network device or on an edge application client 301 of the UE 120. The edge application client 301 on the UE 120 may execute the application that is supported by the application context. The application context may include application data and may include a present state of the application. For example, a user playing an online game may not want to lose a current state of the game, which may include a status of an avatar of the user, a location of the avatar, an inventory of the avatar, an ability of the avatar, and/or the like. If such characteristics of the avatar are not maintained during a mobility event of the UE 120 or during a change in traffic conditions, the user may experience game presentation errors, or the application may fail altogether. If the application is serving a business, the application may affect production or customer relations for the company.

The edge enabler server(s) 307 of the edge data network 303 may handle operations of the edge application server 305, including making decisions to set up and take down the edge application server 305, and perform other custodial functions. The edge enabler server 307 may communicate with an edge configuration server 311, which may configure the edge enabler server 307 and the edge enabler client 309. When an application changes a point of compute, the application context may need to be transferred to another edge enabler server 307. The edge enabler server 307 may thus determine whether an application context needs to be relocated to another edge enabler server.

Some wireless communication devices, such as a network node 110 (e.g., a DU, a CU, or another network device), a UE 120 (e.g., that is enabled for sidelink communications, or exchanging relayed communications with a UE via a network device), or an edge network device 170, may host or offer computation services, such as edge computing. In some examples, the UE 120 may select and attempt to connect to a cell or network node primarily to request and receive computation services from a wireless communication device. The wireless communication device may not be able to provide the service, for example, because it may be computationally overloaded, may not have access to enough resources to fulfill (e.g., obtain a processing result that satisfies) the computation service request, or for energy saving purposes, it may have limitations on offered services. For example, this could be due to computational overload or energy-saving measures that limit the offered services.

One technical consideration arises when the UE 120 requests access to computation services, but lacks prior knowledge about computational load or resource availability of the requested device. The wireless communication device may not have available resources to accommodate the computation service request, and as a result, the UE 120 may waste resources requesting services from a device that does not have available resources. Another consideration concerns UEs that are provided with information regarding network computational load and resource availability. This information may influence the UE decision-making regarding whether to connect to the wireless communication device or to request computation services from the wireless communication device. Further, the mobility of the UE 120 may impact the efficiency of computation service provisioning. For example, if the UE 120 initiates a computation service session with a network node but then moves out of the communication or computation coverage area, providing the requested service may not be efficient or even feasible for the network node. Consequently, there may be a need to consider UE mobility, such as a stationary or mobile state, speed, direction, and expected mobility duration, when deciding whether and how to admit the request for computation services.

As indicated above, FIG. 3 is provided as an example. Other examples may differ from what is described with respect to FIG. 3.

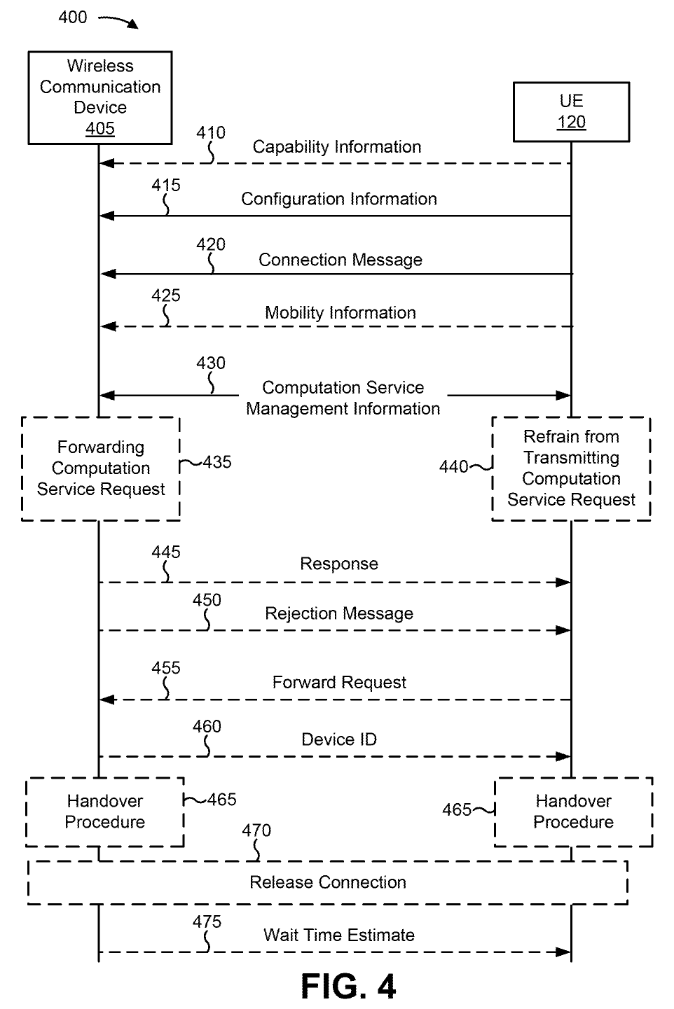

FIG. 4 is a diagram of an example 400 associated with computation load balancing and access control. As shown in FIG. 4, a wireless communication device 405 (e.g., a network node 110, base station, a CU, a DU, an RU, a UE 120, or an edge network device 170) may communicate with a UE 120. In some aspects, the wireless communication device 405 and the UE 120 may be part of a wireless network (e.g., the wireless communication network 100). The UE 120 and the wireless communication device 405 may have established a wireless connection prior to operations shown in FIG. 4.

In some aspects, as shown by reference number 410, the UE 120 may transmit capability information. The capability information may be included in a capability report. The UE 120 may transmit the capability information via an uplink communication, a sidelink communication, a unicast communication, a broadcast communication, a UE assistance information (UAI) communication, an uplink control information (UCI) communication, a sidelink control information (SCI) communication, a MAC control element (MAC-CE) communication, an RRC communication, a physical uplink control channel (PUCCH), a physical uplink shared channel (PUSCH), a physical sidelink control channel (PSCCH), or a physical sidelink shared channel (PSSCH), among other examples. The capability information may indicate one or more parameters associated with respective capabilities of the UE 120. The one or more parameters may be indicated via respective information elements (IEs) included in a capability report.

The capability information may indicate whether the UE 120 supports a feature or one or more parameters related to the feature. For example, the capability information may indicate a capability or parameter for computation load balancing and access control. As another example, the capability information may indicate a capability or parameter for communicating computation service management information. One or more operations described herein may be based on capability information. For example, the UE 120 may perform a communication in accordance with the capability information, or may receive configuration information that is in accordance with the capability information.

As shown by reference number 415, the wireless communication device 405 may transmit, and the UE 120 may receive, configuration information. In some aspects, the UE 120 may receive the configuration information via one or more of system information signaling (e.g., a master information block (MIB) or a system information block (SIB), among other examples), RRC signaling, MAC signaling (e.g., one or more MAC-CEs), or physical layer signaling (e.g., DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC CEs or one or more DCI messages, among other examples.

In some aspects, the configuration information may include an indication of a selection of one or more configuration parameters (e.g., a selection of the one or more configuration parameters already known to the UE 120 or previously indicated by the network node or other network device), or explicit configuration information for the UE 120 to use to configure the UE 120, among other examples.

In some examples, the configuration information may not be expressly signaled to the UE 120. For example, in some aspects, the configuration information may at least partially be defined by a wireless communication standard, such as the 3GPP. In such examples, the wireless communication device 405 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than or in addition to explicitly indicating the information).

In some aspects, the configuration information may indicate at least one of a computation load, available computation resources (e.g., of the wireless communication device 405, or information indicating a wait time for computation services from the wireless communication device 405). In some such aspects, the computation service management information described in connection with reference number 430 may include a computation service request. In some aspects, the configuration information may be communicated as part of a connection procedure between the wireless communication device 405 and the UE 120, or as part of the computation service management information.

The UE 120 may configure itself based at least in part on the configuration information. In some aspects, the UE 120 may be configured to perform one or more operations described herein based at least in part on the configuration information.

In some aspects, the configuration information may indicate at least one of computation load, available computation resources, or information indicating a wait time for computation services from the wireless communication device 405, wherein the computation service management information includes a computation service request. For example, the wireless communication device 405 may receive detailed configuration information from the UE 120, helping to assess the current computation load and resource availability. Configuration information allows for more accurate resource planning and allocation.

Additionally, or alternatively, the configuration information may indicate a timing of at least one of a connection attempt or a requested computation service. For example, the configuration information may specify a time at which the UE 120 may transmit a connection request or a computation service request. In some aspects, the timing may be greater than or equal to the indicated wait time. In some aspects, the timing may indicate a duration to fulfill the requested computation service. Timing information helps synchronize resource allocation with service requirements.

In some aspects, as shown by reference number 420, the UE 120 may transmit, and the wireless communication device 405 may receive, a connection message to initiate a connection, with the wireless communication device 405, for requesting a computation service from the wireless communication device 405.

In some aspects, as shown by reference number 425, the UE 120 may transmit, and the wireless communication device 405 may receive, mobility information. For example, the UE 120 may transmit mobility information of the UE 120. In such aspects, the computation service management information may indicate whether the wireless communication device 405 accepts or denies a computation service request in accordance with the mobility information of the UE 120. For example, the UE 120 may transmit mobility information indicating whether the UE 120 is stationary or moving, and the wireless communication device 405 may use this information to decide whether to accept or deny the computation service request. Mobility information helps increase a likelihood that computation services are provided to UEs capable of maintaining a stable connection or that the communication of provided computation services accounts for potential degradation in communication quality. For example, the UE 120 may provide detailed mobility metrics, such as current speed and direction, to the wireless communication device 405. Detailed mobility metrics may help the wireless communication device 405 to make more informed decisions about computation service allocation.

Additionally, or alternatively, the mobility information of the UE 120 may indicate whether the UE 120 is stationary or mobile and include at least one of velocity, speed, direction, or a quantized level of mobility of the UE 120. For example, the UE 120 may provide detailed mobility metrics, such as current speed and direction, to the wireless communication device 405. Detailed mobility metrics may help the network to make more informed decisions about computation service allocation.

As shown by reference number 430, the wireless communication device 405 and the UE 120 may communicate computation service management information. For example, the UE 120 may send a request for computation services to the wireless communication device 405 when the UE 120 has obtained a complex data processing task. This feature allows the UE 120 to offload intensive computations to the network, thereby conserving battery life and processing capacity.

In some aspects, communicating the computation service management information may include the UE 120 transmitting, and the wireless communication device 405 receiving, a computation service request in accordance with transmitting the connection message. In some aspects, the UE 120 may transmit a computation service request along with the initial connection message to the wireless communication device 405 such that the computation request is processed as part of the connection setup. Combining the computation service request with the connection message may streamline the setup process and reduce latency. In some other aspects, the connection message may indicate that the UE 120 is going to transmit the computation service request. For example, the connection message may indicate that the connection is only for requesting computation services, or is for requesting computation services and for enabling at least one other type of communication (e.g., any type of communication that can be performed after an access procedure). As a result, the wireless communication device 405 may receive the connection message and be able to determine whether or not to perform an access procedure with the UE 120 (e.g., such as a random access procedure), which may help avoid expending overhead and/or power on executing an access procedure, for example, when the connection request is only for requesting computation services and the wireless communication device 405 does not have sufficient processing resources to handle the computation service request.

Additionally, or alternatively, the computation service request may indicate a quality of service associated with the computation service. For example, the computation service request may include parameters specifying the required processing speed or latency for the service. By the UE 120 indicating the quality of service, the wireless communication device 405 may allocate computational resources accordingly to meet the computation needs of the UE 120.

In some aspects, communicating the computation service management information may include receiving, from the wireless communication device 405, an indication of available computation service resources in response to transmitting the connection message. For example, the wireless communication device 405 may transmit, and the UE 120 may receive, information regarding available computation resources of the wireless communication device 405 after the connection message is transmitted. Receiving information indicating available computation resources helps the wireless communication device 405 to manage and optimize resource allocation.

Additionally, or alternatively, the indication of available computation resources may be received during a connection procedure triggered by the connection message or after the connection procedure triggered by the connection message. For example, the wireless communication device 405 may receive the available resources indication either during the initial setup or as a follow-up message after the connection is established. Flexibility in timing allows for dynamic adjustments based on resource availability.

In some aspects, the UE 120 may transmit a computation service request may in accordance with receiving an indication of sufficient available resources. For example, upon confirming that the wireless communication device 405 has adequate computation resources, the UE 120 may proceed with transmitting the computation service request. Efficient use of available resources may enhance service quality and reduce processing delays.

Additionally, or alternatively, communicating the computation service management information may include receiving, in response to the connection message, an estimate of a wait time before a subsequent connection attempt for requesting the computation service. For example, the wireless communication device 405 may inform the UE 120 of the expected wait time before the UE 120 may attempt requesting or re-requesting the computation services. In some aspects, the computation service management information may indicate timing information. For example, the computation service management information may specify a time at which the UE 120 may transmit a subsequent connection request or a computation service request. In some aspects, the timing may be greater than or equal to the indicated wait time. In some aspects, the timing may indicate a duration to fulfill the requested computation service.

In some aspects, as shown by reference number 435, the wireless communication device 405 may forward a computation service request. Alternatively, if the wireless communication device 405 determines that there are insufficient sufficient computation resources in the system, the wireless communication device 405 may decide not to forward the computation service request to another device. Avoiding unnecessary requests prevents overloading the network and helps maintain efficient operation.

In some aspects, as shown by reference number 440, the UE 120 may refrain from transmitting a computation service request. For example, refraining from transmitting the computation service request may be in accordance with receiving an indication of insufficient available resources as part of communicating the computation service management information described in connection with reference number 430.

In some aspects, as shown by reference number 445, the wireless communication device 405 may transmit, and the UE 120 may receive, a response to the computation service management request described in connection with reference number 430. For example, the wireless communication device 405 may inform the UE 120 whether the request for computation services is accepted, forwarded to another device, or rejected due to resource constraints. In some aspects, the wireless communication device 405 may transmit, and the UE 120 may receive, in response to the connection message or as part of the response message, an estimate of a wait time before a subsequent connection attempt for requesting the computation service. This feature provides the UE 120 with immediate feedback, enabling the UE 120 to make informed decisions about subsequent actions, such as re-requesting the computation service, transmitting the computation service request to another device, or reattempting to establish a connection with the wireless communication device 405.

In some aspects, as shown by reference number 450, the UE 120 may receive, and the wireless communication device 405 may transmit, a rejection message. For example, in some aspects, the UE 120 may receive, and the wireless communication device 405 may transmit, a rejection notice of the computation service, where the computation service management information includes a computation service request. For example, the wireless communication device 405 may inform the UE 120 that the computation service request has been denied due to resource constraints or other factors. Receiving a rejection notice allows the UE 120 to understand the outcome of the computation service request and adjust any further actions accordingly.

Additionally, or alternatively, the rejection notice may include a cause value indicating a reason for rejection. For example, the rejection notice may specify that the denial was due to insufficient computation resources, inability to meet a requested quality of service, or high network load. The cause value may include a numerical indication that maps to a defined cause. Providing a cause value helps the UE 120 to understand the specific reason for the rejection and to plan next steps accordingly.

In some aspects, the rejection message may include timing information. For example, the rejection message may specify a time at which the UE 120 may transmit a subsequent connection request or a computation service request in response to the rejection message. In some aspects, the time may be an estimated time, a maximum time, a minimum, time, an average time or a range of time during which the UE 120 may transmit a subsequent connection request or a computation service request in response to the rejection message.

In some aspects, as shown by reference number 455, the UE 120 may transmit, and the wireless communication device 405 may receive, a forward request. For example, the UE 120 transmitting a forward request may be to offload the computation service to an additional wireless communication device in response to receiving the indication of available computation service resources. For example, the UE 120 may request that the wireless communication device 405 forward the computation task to another nearby device that has available resources when the wireless communication device 405 indicates that it has insufficient resources. Utilizing additional devices for computation offloading may balance the load and enhance overall network performance.

In some aspects, as shown by reference number 460, the wireless communication device 405 may transmit, and the UE 120 may receive, an identifier of the additional wireless communication device (e.g., to which the computation service is offloaded). For example, the UE 120 may receive an identifier for the target UE or target wireless communication device that will handle the computation task. Identifying the target device may support proper routing and execution of the offloaded computation service or the completed processing task.

In some aspects, as shown by reference number 465, the UE 120 or the wireless communication device 405 or both may perform a handover procedure. In some aspects, initiating the handover procedure may be based on conditions associated with an ongoing computation service at the wireless communication device 405. For example, the wireless communication device 405 may trigger a handover to another UE 120 if the ongoing computation service cannot be completed due to changing conditions. Initiating handovers based on computation service conditions may support continuity and efficient task completion.

In some aspects, performing a handover procedure with an additional wireless communication device may be in accordance with the computation service management information including an indication of insufficient computation service resources. For example, the wireless communication device 405 may initiate a handover to another UE that has the required computation resources. Conducting handovers based on resource availability may support the efficient handling of computation tasks.

In some aspects, initiating a handover procedure may be based on conditions associated with an ongoing computation service at the wireless communication device 405. For example, the wireless communication device 405 may trigger a handover to another UE 120 if the ongoing computation service cannot be completed due to changing conditions. Initiating handovers based on computation service conditions may support continuity and efficient task completion.

As shown by reference number 470, the wireless communication device 405 may release a connection with the UE 120. In some aspects, releasing the connection with the UE 120 may be caused or preempted by the computation capacity of the wireless communication device 405 being insufficient for the computation service. For example, the computation service management information, described in connection with reference number 430, may include a connection release message that triggers the UE 120 to transition to an idle state or an inactive state. Additionally, or alternatively, releasing a connection with the UE 120 may be in association with the computation capacity of the wireless communication device 405 being insufficient for the computation service. For example, the wireless communication device 405 may release the connection with the UE 120 connection if the wireless communication device 405 cannot handle the computation service request, prompting the UE 120 to try reconnecting later or to request computation services from another device. In some aspects, releasing the connection may help manage network load and avoid resource strain.

In some aspects, the computation service management information may include a connection release message that triggers the UE 120 to transition to an idle state or an inactive state. For example, the wireless communication device 405 may transmit a connection release message to the UE 120 if no computation resources are available, prompting the UE 120 to enter an idle or inactive state. By the UE 120 transitioning to an idle or inactive state, the wireless communication device 405 or the network may experience a reduced load and the UE 120 may conserve battery life.

As shown by reference number 475, in some aspects, the wireless communication device 405 may transmit, and the UE 120 may receive, in response to the connection message described in connection with reference number 420, an estimate of a wait time before a subsequent connection attempt for requesting the computation service. In some aspects, the wait time is received as part of or subsequently to the connection release message described in connection with reference number 470.

As indicated above, FIG. 4 is provided as an example. Other examples may differ from what is described with respect to FIG. 4.

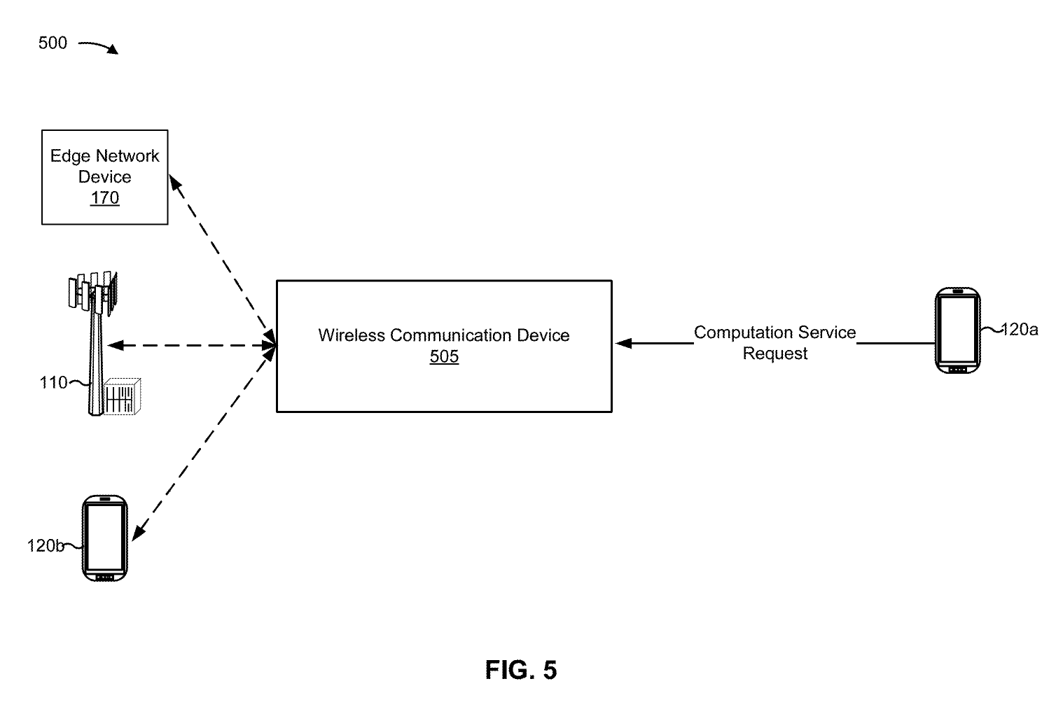

FIG. 5 is a diagram illustrating an example 500 of computation load balancing and access control. As shown in FIG. 5, a UE 120a, a wireless communication device 505 (which may be an example of or in communication with a network node 110, another UE 120, or an edge network device 170), a network node 110, a UE 120b, or an edge network device 170 may communicate with one another.

In some scenarios, the UE 120a may not have information regarding a processing load or available computation resources of the wireless communication device 505. For example, a processing load of the wireless communication device 505 may be a portion of the total processing units, memory units, or storage units (e.g., total available to the device, or total that are configured for computational services) of the wireless communication device 505 that are being used for one or more other tasks or processing tasks. Available computation resources of the wireless communication device 505 may be an available portion of the total processing units, memory units, or storage units (e.g., total available to the device, or total that are configured for computational services) of the wireless communication device 505 that are not being used for one or more other tasks or processing tasks or are available to be used to fulfill the computation service request. In such aspects, the UE 120a may attempt to establish a connection, with the wireless communication device 505, for requesting a computation service. For example, the UE 120a may transmit a connection message to initiate a connection procedure (e.g., a random access procedure, an RRC connection procedure, an initial access procedure, a handover procedure, among other examples). In some aspects, the connection message may indicate whether the connection will be for requesting computation services and whether one or more other communications are to be performed via the connection. When the wireless communication device 505 has available computation resources, the computation service request may be accepted. When the wireless communication device 505 lacks suitable resources to fulfill the request, several actions may be performed. For example, the wireless communication device 505 may forward the computation service request to another device, such as the UE 120b, the network node 110, or the edge network device 170. In some other aspects, the wireless communication device 505 may reject the computation service request or transmit a rejection indication to the UE 120a. In some aspects,, the rejection indication may include a cause value that indicates a reason for the rejection. The cause value may include a numerical value that maps to a reason for the rejection.

In some aspects, the wireless communication device 505 may hand over the UE 120a to another device having available resources. In some aspects, the wireless communication device 505 may release the connection with the UE 120a, and the UE 120a may transition to an idle or inactive state. Thus, the connection message indicating whether the connection is for only requesting computation services, or for requesting computation services and for one or more other communications may help the wireless communication device 505 determine whether to perform the access procedure with the UE 120a. For example, the wireless communication device 505 may reject the connection, delay the connection, or initiate a handover procedure when the connection is only for requesting computation services and the wireless communication device 505 has insufficient resources for fulfilling a computation service request. In another example, the wireless communication device 505 may accept the connection (e.g., perform a connection procedure with the UE 120a) when the connection is for requesting computation services and for another type of communication even when the wireless communication device 505 has insufficient resources for fulfilling a computation service request. In some aspects, the wireless communication device 505 may perform the connection procedure with the UE 120a regardless of the indicated intention for the connection or available processing resources of the wireless communication device 505 and may receive the computation service request before making a subsequent decision or performing a subsequent action regarding the computation service request.

In some aspects, the UE 120a may make multiple requests for different types of tasks, and the subsequent actions of the wireless communication device 505 may apply to all requests or the wireless communication device 505 may treat each request differently or groups of requests may be treated differently. For instance, some requests or groups of requests may be accepted, while others may be rejected or forwarded to another entity, or all requests may be accepted, forwarded, rejected, or delayed. In one example, the UE 120a may be configured for dual or multi-connection, where one of the connections to a CU, DU, or cell group is primarily for providing computation services for some or all of the UE 120a requests.

When the wireless communication device 505 forwards the computation service request to another device to accommodate the computation service request, the wireless communication device 505 may inform the UE 120a about the status of the computation service request. For example, the wireless communication device 505 may indicate whether the computation service request is being served locally. If the computation service request is not being served locally, the wireless communication device 505 may provide additional information indicating the identifier or type of the service provider handling the computation service request. In some such scenarios, the UE 120a may remain connected to the same cell or device for communication purposes.

When the wireless communication device 505 rejects the computation service request, the wireless communication device 505 may indicate the cause of the rejection to the UE 120a. For example, the wireless communication device 505 may transmit a rejection notice that includes a cause value that maps to a reason for the rejection. Possible reasons for rejection may include no available resources, the inability to meet the required computation quality of service (QoS), or an availability of network load. In examples where the primary reason for the UE connection was to obtain computation services (e.g., as indicated by the connection message_, the connection request may be rejected, and the cause for rejection may be indicated as being associated with the denial of the required computation service. The cause value indicated by the UE 120a in messages such as a third message of an access procedure or a message A of an access procedure (e.g., in the RRC setup request). Some connection messages may be expanded to support indications like “computation-only,” “computation and communication,” or “communication-only.” For each category, additional information or sub-causes may be provided to give more context to the rejection. For example, the cause value may map to connection types like “computation-only,” “computation and communication,” or “communication-only,” such that a cause value may map to a connection type such as “computation-only” and may further map to a sub-cause, such as “no available processing resources”. As another example, sub-causes may map to causes and sub-causes and may not map to connection types. For example, the cause value may map to general causes such as available resources, the inability to meet the required QoS, or an availability of network load, and a sub-cause that gives further details regarding the rejection, such as a degree to which the wireless communication device 505 is unable to fulfill the request (e.g., no resources available, some but insufficient resources available, most resources available, a lowest QoS tier that the wireless communication device 505 is unable to meet (e.g., implying lower QoS tiers are able to be met), one or more specific details regarding network load), such that the UE 120a can decide whether to adjust the computation service request, abandon the computation service request, or delay the computation service request, among other examples. Thus, sub-clauses may inform the UE 120a of conditions at the wireless communication device 505 such that the UE 120a may avoid waiting for or re-requesting computational services from a device that cannot fulfill the request. In another aspect, the UE 120a may evaluate whether it would be more efficient to wait for the services from the device based on the cause values or to request services elsewhere.

These aspects ensure that the UE 120a is kept informed about the status of the computation service requests and the reasons for any rejections, allowing for more efficient management of resources and better user experience.

When the wireless communication device 505 hands over the UE 120a to another device due to unavailable computation resources, or unsupported requested computation services or associated quality of service, a “cause” value may be indicated in the handover request. This value may indicate the reason for the handover, such as “no available computation resources at the requested device” or “not supported requested computation service or an associated QoS is not supported,” among other examples. Additionally or alternatively, information and context about the computation service requested by the UE 120a may be exchanged between the two devices as part of the handover procedure or UE context transfer, supporting continuity of the requested service.

In scenarios where the wireless communication device 505 rejects or releases the connection, the wireless communication device 505 may provide an estimate or range of the wait time for the UE 120a. This information may include maximum, minimum, mean, or range values for the wait time. The UE 120a may then attempt to reconnect after the indicated wait time has elapsed. Upon reattempting to connect, the UE 120a may indicate that the UE 120a has waited for the specified amount of time. Additionally, the UE 120a may be paged when the wireless communication device 505 is ready to accommodate the computation service request, using a new paging cause specifically for this purpose.

In some aspects, the UE 120a may receive information indicating the load/available computation resources offered by the wireless communication device 505. For example, such information may include a current processing load of the wireless communication device 505, available resources, information indicating a wait time (e.g., a time at which the wireless communication device 505 will have available processing resources for the computation request of the UE 120a). In such aspects, the UE 120a may use this information as assistance information or may perform one or more other actions or decisions based on the information. In some aspects, the information may support a computation load control mechanism (e.g., similar to or an extension of unified access control (UAC)).

UAC may provide a mechanism for access barring of UEs, such as in an access network associated with a core network, or in a core network. For example, UAC may provide for UEs associated with a certain access identity to be barred from accessing a network. This may be helpful in high-congestion scenarios to increase a likelihood that more important, higher priority UEs may access the network. The next generation radio access network (NG-RAN) may broadcast access barring control information associated with access categories and access identities (in the case of network sharing, the barring control information may be set individually for each public land mobile network (PLMN)). A UE may determine whether an access attempt is allowed or barred based at least in part on the barring information broadcast for a selected PLMN, and the selected access category and access identity for the access attempt. For example, for non-access stratum (NAS) triggered requests, an NAS layer may determine the access category and access identity, and for access stratum (AS) triggered requests, a radio resource control (RRC) layer of the UE 120a may determine the access category, and the NAS layer may determine the access identity.

In some aspects, the wireless communication device 505 or the UE 120a or both may support an access control mechanism for the purpose of computation load balancing, where the access of the UE 120a (e.g., in terms of attempting to connect for the purpose of computation services and/or requesting computation services) may be controlled by, configured by, or indicated by one or more logical rules according to the provided information. For example, this may be similar to UAC, where new access categories and/or access IDs (e.g., IDs associated with computation services) may be defined or indicated. In such aspects, the UE 120a may be barred from accessing or requesting computation services from the wireless communication device 505 or may delay access/requests according to a minimum or random wait time (e.g., one or more logical rules associated with a minimum or random wait time). Such configurations may be provided by a network device, or may be configured at the UE 120a and may be different for different categories, IDs, tasks, types, QoS requirements, among other examples, of the processing load.

In some aspects, the access limitation (or wait time) may be applicable to all cells belonging to the same group of cells, or the wireless communication device 505 (e.g., devices sharing the same computation resources), and as a result, the associated configurations or rules for access may be indicated or configured for a set of cells, or an area (e.g., as opposed to cell-specific rules and configurations).

In some aspects, when deciding to admit a request for a computation service, the UE mobility should be taken into account. For example, when the computation is done locally but the UE 120a is likely to move outside the communication or computation coverage area, it may not be efficient to admit and initiate the service for the UE 120a. As long as information regarding the UE mobility is shared with the network node early on, the network may decide whether to accept or reject the computation service request. Some aspects may support the early indication of information regarding UE mobility. This includes whether the UE 120a is stationary or mobile, whether the UE 120a is expected to remain stationary or mobile for a minimum configured or indicated amount of time, velocity or speed, direction, and a quantized level of mobility (e.g., low, medium, high) defined based on some specified or configured rules. These rules may depend on the amount of variation in the radio frequency measurements, distance, speed, or the number of selected or visited cells or beams.

This information may be carried during a random access channel (RACH) procedure, such as in a message 3 or other messages. Additionally, this information may be carried along with the computation request. In one example, the UE 120a may indicate this information, when available, when requesting a computation service.

In some aspects, conditions based on the mobility of the UE 120a may be configured or indicated. In such aspects, the UE 120a may select a wireless communication device for the computation service according to the conditions or may transmit a computation service when the conditions are met. In some aspects, different conditions may be supported or defined for different types of services or tasks.

It is important to support the early indication of information regarding the mobility state. This includes whether the UE 120a is stationary or mobile, whether the UE 120a is expected to remain stationary or mobile for a minimum configured or indicated amount of time, velocity or speed, direction, and a quantized level of mobility (e.g., low, medium, high) defined based on some specified or configured rules. These rules may depend on the amount of variation in the radio frequency measurements, distance, speed, or the number of selected or visited cells or beams.

In one scenario, a UE starts a computation service session with the wireless communication device 505 but then begins moving toward a second device. For example, the UE 120a may go back to an idle or inactive mode and wait while the computation session is ongoing. When the processing job is ready, the UE 120a may be paged. For example, when the UE 120a has already moved to another cell or the second device, the UE 120a may be paged through RAN or core network paging. In such aspects, the processing results may be forwarded to the UE 120 that is connected to the cell or the second device, or the UE 120 may attempt to re-establish a connection with the wireless communication device 505.

In some aspects, computation-related data generated at a source network node (DU/CU) may be transferred to the UE 120a via a new serving network node. In some aspects, connected UE mobility may be accounted for. For example, when the computation remains with the original device (e.g., the wireless communication device 505), the results may be routed to the UE 120a.

Some aspects may support new events or conditions for triggering a conditional handover or lower-layer triggered mobility procedures, where these conditions are at least partly based on the amount of computation remaining or the time remaining to complete a computation service at the wireless communication device 505. In some aspects, the UE 120a may delay or advance execution of a conditional handover or lower-layer triggered mobility procedure. For example, the UE 120a may receive a computation status indication from the wireless communication device 505 that may trigger the execution of conditional handover or lower-layer triggered mobility procedure.

As indicated above, FIG. 5 is provided as an example. Other examples may differ from what is described with respect to FIG. 5.

FIG. 6 is a diagram illustrating an example process 600 performed, for example, at a UE or an apparatus of a UE. Example process 600 is an example where the apparatus or the UE (e.g., UE 120) performs operations associated with computation load balancing and access control.

As shown in FIG. 6, in some aspects, process 600 may include transmitting, to a wireless communication device, a connection message to initiate a connection with the wireless communication device, wherein the connection is for requesting a computation service from the wireless communication device (block 610). For example, the UE (e.g., using transmission component 804 or communication manager 806, depicted in FIG. 8) may transmit, to a wireless communication device, a connection message to initiate a connection with the wireless communication device, wherein the connection is for requesting a computation service from the wireless communication device, as described above.

As further shown in FIG. 6, in some aspects, process 600 may include communicating computation service management information with the wireless communication device, wherein the computation service management information is associated with a computation capacity of the wireless communication device (block 620). For example, the UE (e.g., using reception component 802, transmission component 804, or communication manager 806, depicted in FIG. 8) may communicate computation service management information with the wireless communication device, wherein the computation service management information is associated with a computation capacity of the wireless communication device, as described above.

Process 600 may include additional aspects, such as any single aspect or any combination of aspects described below or in connection with one or more other processes described elsewhere herein.

In a first aspect, communicating the computation service management information comprises transmitting a computation service request in accordance with transmitting the connection message.

In a second aspect, alone or in combination with the first aspect, the computation service request indicates a quality of service associated with the computation service.

In a third aspect, alone or in combination with one or more of the first and second aspects, communicating the computation service management information comprises receiving, from the wireless communication device, an indication of available computation service resources in response to transmitting the connection message.

In a fourth aspect, alone or in combination with one or more of the first through third aspects, the indication of available computation resources is received during a connection procedure triggered by the connection message or after the connection procedure triggered by the connection message.

In a fifth aspect, alone or in combination with one or more of the first through fourth aspects, process 600 includes refraining from transmitting a computation service request in response to receiving an indication of insufficient available resources.

In a sixth aspect, alone or in combination with one or more of the first through fifth aspects, process 600 includes transmitting a computation service request in response to receiving an indication of sufficient available resources.

In a seventh aspect, alone or in combination with one or more of the first through sixth aspects, process 600 includes transmitting a forward request to offload the computation service to an additional wireless communication device in response to receiving the indication of available computation service resources.

In an eighth aspect, alone or in combination with one or more of the first through seventh aspects, process 600 includes receiving an identifier of the additional wireless communication device.

In a ninth aspect, alone or in combination with one or more of the first through eighth aspects, process 600 includes receiving a rejection notice of the computation service, wherein the computation service management information includes a computation service request.

In a tenth aspect, alone or in combination with one or more of the first through ninth aspects, the rejection notice includes a cause value indicating a reason for rejection.

In an eleventh aspect, alone or in combination with one or more of the first through tenth aspects, process 600 includes performing a handover procedure with an additional wireless communication device in accordance with the computation service management information including an indication of insufficient computation service resources.

In a twelfth aspect, alone or in combination with one or more of the first through eleventh aspects, the computation service management information includes a connection release message that triggers the UE to transition to an idle state or an inactive state.

In a thirteenth aspect, alone or in combination with one or more of the first through twelfth aspects, process 600 includes receiving, in response to the connection message, an estimate of a wait time before a subsequent connection attempt for requesting the computation service.

In a fourteenth aspect, alone or in combination with one or more of the first through thirteenth aspects, process 600 includes receiving configuration information indicating at least one of computation load, available computation resources, or information indicating a wait time for computation services from the wireless communication device, wherein the computation service management information includes a computation service request.

In a fifteenth aspect, alone or in combination with one or more of the first through fourteenth aspects, the configuration information indicates a timing of at least one of a connection attempt or a requested computation service.

In a sixteenth aspect, alone or in combination with one or more of the first through fifteenth aspects, process 600 includes transmitting mobility information of the UE, wherein the computation service management information indicates whether the wireless communication device accepts or denies a computation service request in accordance with the mobility information of the UE.

In a seventeenth aspect, alone or in combination with one or more of the first through sixteenth aspects, the mobility information of the UE indicates whether the UE is stationary or mobile and includes at least one of velocity, speed, direction, or a quantized level of mobility of the UE.

In an eighteenth aspect, alone or in combination with one or more of the first through seventeenth aspects, process 600 includes initiating a handover procedure based on conditions associated with an ongoing computation service at the wireless communication device.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a wireless communication device or an apparatus of a wireless communication device. Example process 700 is an example where the apparatus or the wireless communication device (e.g., wireless communication device 405, wireless communication device 505, edge network device 170, network node 110, or UE 120) performs operations associated with computation load balancing and access control.

As shown in FIG. 7, in some aspects, process 700 may include receiving, from a UE, a connection request message that initiates a connection procedure with the UE, wherein the connection request message indicates that the connection request message is associated with a computation service request for a computation service from the wireless communication device (block 710). For example, the wireless communication device (e.g., using reception component 902, or communication manager 906 depicted in FIG. 9) may receive, from a UE, a connection request message that initiates a connection procedure with the UE, wherein the connection request message indicates that the connection request message is associated with a computation service request for a computation service from the wireless communication device, as described above.

As further shown in FIG. 7, in some aspects, process 700 may include communicating computation service management information with the UE, wherein the computation service management information is associated with a computation capacity of the wireless communication device (block 720). For example, the wireless communication device (e.g., using reception component 902, transmission component 904, or communication manager 906, depicted in FIG. 9) may communicate computation service management information with the UE, wherein the computation service management information is associated with a computation capacity of the wireless communication device, as described above.

Process 700 may include additional aspects, such as any single aspect or any combination of aspects described below or in connection with one or more other processes described elsewhere herein.

In a first aspect, process 700 includes transmitting the computation service request to an additional wireless communication device in accordance with the computation capacity of the wireless communication device being insufficient for the computation service.

In a second aspect, alone or in combination with the first aspect, process 700 includes transmitting a rejection message in response to receiving the computation service request in association with the computation capacity of the wireless communication device being insufficient for the computation service.

In a third aspect, alone or in combination with one or more of the first and second aspects, process 700 includes performing a handover procedure for the UE to connect to an additional wireless communication device in association with the computation capacity of the wireless communication device being insufficient for the computation service.

In a fourth aspect, alone or in combination with one or more of the first through third aspects, process 700 includes releasing a connection with the UE in association with the computation capacity of the wireless communication device being insufficient for the computation service.

In a fifth aspect, alone or in combination with one or more of the first through fourth aspects, communicating the computation service management information comprises receiving a plurality of computation service requests, and accepting a subset of the plurality of computation service requests in association with the computation capacity of the wireless communication device being insufficient for the plurality of computation service requests.

In a sixth aspect, alone or in combination with one or more of the first through fifth aspects, communicating the computation service management information comprises transmitting an indication of the computation capacity of the wireless communication device.

In a seventh aspect, alone or in combination with one or more of the first through sixth aspects, communicating the computation service management information comprises receiving a computation service request in response to receiving the connection request message.

In an eighth aspect, alone or in combination with one or more of the first through seventh aspects, the computation service request indicates a quality of service associated with the computation service.

In a ninth aspect, alone or in combination with one or more of the first through eighth aspects, communicating the computation service management information comprises transmitting, to the UE, an indication of available computation service resources in response to transmitting the connection request message.

In a tenth aspect, alone or in combination with one or more of the first through ninth aspects, the indication of available computation resources is transmitted during a connection procedure triggered by the connection request message or after the connection procedure triggered by the connection request message.

In an eleventh aspect, alone or in combination with one or more of the first through tenth aspects, process 700 includes receiving a computation service request in accordance with transmitting an indication of sufficient available resources.

In a twelfth aspect, alone or in combination with one or more of the first through eleventh aspects, process 700 includes receiving a forward request to offload the computation service to an additional wireless communication device in response to transmitting the indication of available computation service resources.

In a thirteenth aspect, alone or in combination with one or more of the first through twelfth aspects, process 700 includes transmitting an identifier of the additional wireless communication device.

In a fourteenth aspect, alone or in combination with one or more of the first through thirteenth aspects, process 700 includes transmitting a rejection notice of the computation service, wherein the computation service management information includes a computation service request.

In a fifteenth aspect, alone or in combination with one or more of the first through fourteenth aspects, the rejection notice includes a cause value indicating a reason for rejection.

In a sixteenth aspect, alone or in combination with one or more of the first through fifteenth aspects, process 700 includes performing a handover procedure with an additional wireless communication device in accordance with the computation service management information including an indication of insufficient computation service resources.

In a seventeenth aspect, alone or in combination with one or more of the first through sixteenth aspects, the computation service management information includes a connection release message that triggers the UE to transition to an idle state or an inactive state.

In an eighteenth aspect, alone or in combination with one or more of the first through seventeenth aspects, process 700 includes transmitting, in response to the connection request message, an estimate of a wait time before a subsequent connection attempt for requesting the computation service.

In a nineteenth aspect, alone or in combination with one or more of the first through eighteenth aspects, process 700 includes transmitting configuration information indicating at least one of computation load, available computation resources, or information indicating a wait time for computation services from the wireless communication device, wherein the computation service management information includes a computation service request.

In a twentieth aspect, alone or in combination with one or more of the first through nineteenth aspects, the configuration information indicates a timing of at least one of a connection attempt or a requested computation service.

In a twenty-first aspect, alone or in combination with one or more of the first through twentieth aspects, process 700 includes receiving mobility information of the UE, wherein the computation service management information indicates whether the wireless communication device accepts or denies a computation service request in accordance with the mobility information.

In a twenty-second aspect, alone or in combination with one or more of the first through twenty-first aspects, the mobility information indicates whether the UE is stationary or mobile and includes at least one of velocity, speed, direction, or a quantized level of mobility of the UE.

In a twenty-third aspect, alone or in combination with one or more of the first through twenty-second aspects, process 700 includes initiating a handover procedure based on conditions associated with an ongoing computation service at the wireless communication device.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIGS. 4-5. Additionally, or alternatively, the apparatus 800 may be configured to perform one or more processes described herein, such as process 600 of FIG. 6, or a combination thereof. In some aspects, the apparatus 800 or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The transmission component 804 may transmit, to a wireless communication device, a connection message to initiate a connection with the wireless communication device, wherein the connection is for requesting a computation service from the wireless communication device. The reception component 802 or the transmission component 804 may communicate computation service management information with the wireless communication device, wherein the computation service management information is associated with a computation capacity of the wireless communication device.

The transmission component 804 may transmit a computation service request in accordance with transmitting the connection message. The reception component 802 may receive an indication of available computation service resources in response to transmitting the connection message.

The communication manager 806 may refrain from transmitting a computation service request in response to receiving an indication of insufficient available resources.

The transmission component 804 may transmit a computation service request in response to receiving an indication of sufficient available resources.

The transmission component 804 may transmit a forward request to offload the computation service to an additional wireless communication device in response to receiving the indication of available computation service resources.

The reception component 802 may receive an identifier of the additional wireless communication device.

The reception component 802 may receive a rejection notice of the computation service, wherein the computation service management information includes a computation service request. The communication manager 806 may perform a handover procedure with an additional wireless communication device in accordance with the computation service management information including an indication of insufficient computation service resources.

The reception component 802 may receive, in response to the connection message, an estimate of a wait time before a subsequent connection attempt for requesting the computation service.

The reception component 802 may receive configuration information indicating at least one of computation load, available computation resources, or information indicating a wait time for computation services from the wireless communication device, wherein the computation service management information includes a computation service request.

The transmission component 804 may transmit mobility information of the UE, wherein the computation service management information indicates whether the wireless communication device accepts or denies a computation service request in accordance with the mobility information of the UE.

The communication manager 806 may initiate a handover procedure based on conditions associated with an ongoing computation service at the wireless communication device.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a wireless communication device, or a wireless communication device may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 150, the communication manager 155, or the communication manager 185 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 or 145 described in connection with FIG. 1) of the wireless communication device.

In some aspects, the apparatus 900 may be configured to perform one or more operations described herein in connection with FIGS. 4-5. Additionally, or alternatively, the apparatus 900 may be configured to perform one or more processes described herein, such as process 700 of FIG. 7, or a combination thereof. In some aspects, the apparatus 900 or one or more components shown in FIG. 9 may include one or more components of the wireless communication device described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the wireless communication device described above in connection with FIG. 1, such as a radio, one or more RF chains, one or more transceivers, or one or more modems, each of which may in turn be coupled with one or more antennas of the wireless communication device.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the wireless communication device described above in connection with FIG. 1, such as a radio, one or more RF chains, one or more transceivers, or one or more modems, each of which may in turn be coupled with one or more antennas of the wireless communication device described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The reception component 902 may receive, from a UE, a connection request message that initiates a connection procedure with the UE, wherein the connection request message indicates that the connection request message is associated with a computation service request for a computation service from the wireless communication device. The reception component 902 or the transmission component 904 may communicate computation service management information with the UE, wherein the computation service management information is associated with a computation capacity of the wireless communication device.

The transmission component 904 may transmit the computation service request to an additional wireless communication device in accordance with the computation capacity of the wireless communication device being insufficient for the computation service.

The transmission component 904 may transmit a rejection message in response to receiving the computation service request in association with the computation capacity of the wireless communication device being insufficient for the computation service.

The communication manager 906 may perform a handover procedure for the UE to connect to an additional wireless communication device in association with the computation capacity of the wireless communication device being insufficient for the computation service.

The communication manager 906 may release a connection with the UE in association with the computation capacity of the wireless communication device being insufficient for the computation service.

The reception component 902 may receive a plurality of computation service requests. The communication manager 906 may accept a subset of the plurality of computation service requests in association with the computation capacity of the wireless communication device being insufficient for the plurality of computation service requests.

The transmission component 904 may transmit an indication of the computation capacity of the wireless communication device. The reception component 902 may receive a computation service request in response to receiving the connection request message. The transmission component 904 may transmit an indication of available computation service resources in response to transmitting the connection request message.

The reception component 902 may receive a computation service request in accordance with transmitting an indication of sufficient available resources.

The reception component 902 may receive a forward request to offload the computation service to an additional wireless communication device in response to transmitting the indication of available computation service resources.

The transmission component 904 may transmit an identifier of the additional wireless communication device.

The transmission component 904 may transmit a rejection notice of the computation service, wherein the computation service management information includes a computation service request.

The communication manager 906 may perform a handover procedure with an additional wireless communication device in accordance with the computation service management information including an indication of insufficient computation service resources.

The transmission component 904 may transmit, in response to the connection request message, an estimate of a wait time before a subsequent connection attempt for requesting the computation service.

The transmission component 904 may transmit configuration information indicating at least one of computation load, available computation resources, or information indicating a wait time for computation services from the wireless communication device, wherein the computation service management information includes a computation service request.

The reception component 902 may receive mobility information of the UE, wherein the computation service management information indicates whether the wireless communication device accepts or denies a computation service request in accordance with the mobility information.

The communication manager 906 may initiate a handover procedure based on conditions associated with an ongoing computation service at the wireless communication device.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: transmitting, to a wireless communication device, a connection message to initiate a connection with the wireless communication device, wherein the connection is for requesting a computation service from the wireless communication device; and communicating computation service management information with the wireless communication device, wherein the computation service management information is associated with a computation capacity of the wireless communication device.

Aspect 2: The method of Aspect 1, wherein communicating the computation service management information comprises: transmitting a computation service request in accordance with transmitting the connection message.

Aspect 3: The method of Aspect 2, wherein the computation service request indicates a quality of service associated with the computation service.

Aspect 4: The method of any of Aspects 1-3, wherein communicating the computation service management information comprises: receiving, from the wireless communication device, an indication of available computation service resources in response to transmitting the connection message.

Aspect 5: The method of Aspect 4, wherein the indication of available computation resources is received during a connection procedure triggered by the connection message or after the connection procedure triggered by the connection message.

Aspect 6: The method of any of Aspects 4 and 5, further comprising: refraining from transmitting a computation service request in response to receiving an indication of insufficient available resources.

Aspect 7: The method of any of Aspects 4 and 5, further comprising: transmitting a computation service request in response to receiving an indication of sufficient available resources.

Aspect 8: The method of any of Aspects 4 and 5, further comprising: transmitting a forward request to offload the computation service to an additional wireless communication device in response to receiving the indication of available computation service resources.

Aspect 9: The method of Aspect 8, further comprising: receiving an identifier of the additional wireless communication device.

Aspect 10: The method of any of Aspects 1-9, further comprising: receiving a rejection notice of the computation service, wherein the computation service management information includes a computation service request.

Aspect 11: The method of Aspect 10, wherein the rejection notice includes a cause value indicating a reason for rejection.

Aspect 12: The method of any of Aspects 1-11, further comprising: performing a handover procedure with an additional wireless communication device in accordance with the computation service management information including an indication of insufficient computation service resources.

Aspect 13: The method of any of Aspects 1-12, wherein the computation service management information includes a connection release message that triggers the UE to transition to an idle state or an inactive state.

Aspect 14: The method of Aspect 13, further comprising: receiving, in response to the connection message, an estimate of a wait time before a subsequent connection attempt for requesting the computation service.

Aspect 15: The method of any of Aspects 1-14, further comprising: receiving configuration information indicating at least one of computation load, available computation resources, or information indicating a wait time for computation services from the wireless communication device, wherein the computation service management information includes a computation service request.

Aspect 16: The method of Aspect 15, wherein the configuration information indicates a timing of at least one of a connection attempt or a requested computation service.

Aspect 17: The method of any of Aspects 1-16, further comprising: transmitting mobility information of the UE, wherein the computation service management information indicates whether the wireless communication device accepts or denies a computation service request in accordance with the mobility information of the UE.

Aspect 18: The method of Aspect 17, wherein the mobility information of the UE indicates whether the UE is stationary or mobile and includes at least one of velocity, speed, direction, or a quantized level of mobility of the UE.

Aspect 19: The method of any of Aspects 1-18, further comprising: initiating a handover procedure based on conditions associated with an ongoing computation service at the wireless communication device.

Aspect 20: A method of wireless communication performed by a wireless communication device, comprising: receiving, from a user equipment (UE), a connection request message that initiates a connection procedure with the UE, wherein the connection request message indicates that the connection request message is associated with a computation service request for a computation service from the wireless communication device; and communicating computation service management information with the UE, wherein the computation service management information is associated with a computation capacity of the wireless communication device.

Aspect 21: The method of Aspect 20, further comprising: transmitting the computation service request to an additional wireless communication device in accordance with the computation capacity of the wireless communication device being insufficient for the computation service.

Aspect 22: The method of any of Aspects 20-21, further comprising: transmitting a rejection message in response to receiving the computation service request in association with the computation capacity of the wireless communication device being insufficient for the computation service.

Aspect 23: The method of any of Aspects 20-22, further comprising: performing a handover procedure for the UE to connect to an additional wireless communication device in association with the computation capacity of the wireless communication device being insufficient for the computation service.

Aspect 24: The method of any of Aspects 20-23, further comprising: releasing a connection with the UE in association with the computation capacity of the wireless communication device being insufficient for the computation service.

Aspect 25: The method of any of Aspects 20-24, wherein communicating the computation service management information comprises: receiving a plurality of computation service requests; and accepting a subset of the plurality of computation service requests in association with the computation capacity of the wireless communication device being insufficient for the plurality of computation service requests.

Aspect 26: The method of any of Aspects 20-25, wherein communicating the computation service management information comprises: transmitting an indication of the computation capacity of the wireless communication device.

Aspect 27: The method of any of Aspects 20-26, wherein communicating the computation service management information comprises: receiving a computation service request in response to receiving the connection request message.

Aspect 28: The method of Aspect 27, wherein the computation service request indicates a quality of service associated with the computation service.

Aspect 29: The method of any of Aspects 20-28, wherein communicating the computation service management information comprises: transmitting, to the UE, an indication of available computation service resources in response to transmitting the connection request message.

Aspect 30: The method of Aspect 29, wherein the indication of available computation resources is transmitted during a connection procedure triggered by the connection request message or after the connection procedure triggered by the connection request message.

Aspect 31: The method of any of Aspects 29 and 30, further comprising: receiving a computation service request in accordance with transmitting an indication of sufficient available resources.

Aspect 32: The method of any of Aspects 29-31, further comprising: receiving a forward request to offload the computation service to an additional wireless communication device in response to transmitting the indication of available computation service resources.

Aspect 33: The method of Aspect 32, further comprising: transmitting an identifier of the additional wireless communication device.

Aspect 34: The method of any of Aspects 20-33, further comprising: transmitting a rejection notice of the computation service, wherein the computation service management information includes a computation service request.

Aspect 35: The method of Aspect 34, wherein the rejection notice includes a cause value indicating a reason for rejection.

Aspect 36: The method of any of Aspects 20-35, further comprising: performing a handover procedure with an additional wireless communication device in accordance with the computation service management information including an indication of insufficient computation service resources.

Aspect 37: The method of any of Aspects 20-36, wherein the computation service management information includes a connection release message that triggers the UE to transition to an idle state or an inactive state.

Aspect 38: The method of Aspect 37, further comprising: transmitting, in response to the connection request message, an estimate of a wait time before a subsequent connection attempt for requesting the computation service.

Aspect 39: The method of any of Aspects 20-38, further comprising: transmitting configuration information indicating at least one of computation load, available computation resources, or information indicating a wait time for computation services from the wireless communication device, wherein the computation service management information includes a computation service request.

Aspect 40: The method of Aspect 39, wherein the configuration information indicates a timing of at least one of a connection attempt or a requested computation service.

Aspect 41: The method of any of Aspects 20-40, further comprising: receiving mobility information of the UE, wherein the computation service management information indicates whether the wireless communication device accepts or denies a computation service request in accordance with the mobility information.

Aspect 42: The method of Aspect 41, wherein the mobility information indicates whether the UE is stationary or mobile and includes at least one of velocity, speed, direction, or a quantized level of mobility of the UE.

Aspect 43: The method of any of Aspects 20-42, further comprising: initiating a handover procedure based on conditions associated with an ongoing computation service at the wireless communication device.

Aspect 44: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-43.

Aspect 45: An apparatus for wireless communication at a device, the apparatus comprising one or more memories and one or more processors coupled to the one or more memories, the one or more processors configured to cause the device to perform the method of one or more of Aspects 1-43.

Aspect 46: An apparatus for wireless communication, the apparatus comprising at least one means for performing the method of one or more of Aspects 1-43.

Aspect 47: A non-transitory computer-readable medium storing code for wireless communication, the code comprising instructions executable by one or more processors to perform the method of one or more of Aspects 1-43.

Aspect 48: A non-transitory computer-readable medium storing a set of instructions for wireless communication, the set of instructions comprising one or more instructions that, when executed by one or more processors of a device, cause the device to perform the method of one or more of Aspects 1-43.

Aspect 49: A device for wireless communication, the device comprising a processing system that includes one or more processors and one or more memories coupled with the one or more processors, the processing system configured to cause the device to perform the method of one or more of Aspects 1-43.

Aspect 50: An apparatus for wireless communication at a device, the apparatus comprising one or more memories and one or more processors coupled to the one or more memories, the one or more processors individually or collectively configured to cause the device to perform the method of one or more of Aspects 1-43.

Aspect 51: A device comprising a processing system that includes one or more processors and one or more code-storing memories coupled with the one or more processors, the processing system configured to cause the device to perform the method of one or more of Aspects 1-43.

Aspect 52: A device comprising a processing system that includes processor circuitry and code-storing memory circuitry, the processing system configured to cause the device to perform the method of one or more of Aspects 1-43.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
transmit, to a wireless communication device, a connection message to initiate a connection with the wireless communication device, wherein the connection is for requesting a computation service from the wireless communication device; and
communicate computation service management information with the wireless communication device, wherein the computation service management information is associated with a computation capacity of the wireless communication device.

2. The UE of claim 1, wherein the processing system, to cause the UE to communicate the computation service management information, is configured to cause the UE to:
transmit a computation service request in accordance with transmitting the connection message.

3. The UE of claim 1, wherein the processing system, to cause the UE to communicate the computation service management information, is configured to cause the UE to:
receive, from the wireless communication device, an indication of available computation service resources in response to transmitting the connection message.

4. The UE of claim 3, wherein the indication of available computation resources is received during a connection procedure triggered by the connection message or after the connection procedure triggered by the connection message.

5. The UE of claim 3, wherein the processing system is configured to cause the UE to:
refrain from transmitting a computation service request in response to receiving an indication of insufficient available resources.

6. The UE of claim 3, wherein the processing system is configured to cause the UE to:
transmit a computation service request in response to receiving an indication of sufficient available resources.

7. The UE of claim 3, wherein the processing system is configured to cause the UE to:
transmit a forward request to offload the computation service to an additional wireless communication device in response to receiving the indication of available computation service resources.

8. The UE of claim 1, wherein the processing system is configured to cause the UE to:
receive a rejection notice of the computation service, wherein the computation service management information includes a computation service request.

9. The UE of claim 1, wherein the processing system is configured to cause the UE to:
perform a handover procedure with an additional wireless communication device in accordance with the computation service management information including an indication of insufficient computation service resources.

10. The UE of claim 1, wherein the computation service management information includes a connection release message that triggers the UE to transition to an idle state or an inactive state.

11. The UE of claim 10, wherein the processing system is configured to cause the UE to:
receive, in response to the connection message, an estimate of a wait time before a subsequent connection attempt for requesting the computation service.

12. The UE of claim 1, wherein the processing system is configured to cause the UE to:
receive configuration information indicating at least one of computation load, available computation resources, or information indicating a wait time for computation services from the wireless communication device, wherein the computation service management information includes a computation service request.

13. The UE of claim 1, wherein the processing system is configured to cause the UE to:
transmit mobility information of the UE, wherein the computation service management information indicates whether the wireless communication device accepts or denies a computation service request in accordance with the mobility information of the UE.

14. The UE of claim 1, wherein the processing system is configured to cause the UE to:
initiate a handover procedure based on conditions associated with an ongoing computation service at the wireless communication device.

15. A wireless communication device, comprising:
a processing system that includes one or more processors and one or more code-storing memories coupled with the one or more processors,
the processing system configured to cause the wireless communication device to:
receive, from a user equipment (UE), a connection request message that initiates a connection procedure with the UE, wherein the connection request message indicates that the connection request message is associated with a computation service request for a computation service from the wireless communication device; and
communicate computation service management information with the UE, wherein the computation service management information is associated with a computation capacity of the wireless communication device.

16. The wireless communication device of claim 15, wherein the processing system is configured to cause the wireless communication device to:
perform a handover procedure for the UE to connect to an additional wireless communication device in association with the computation capacity of the wireless communication device being insufficient for the computation service.

17. The wireless communication device of claim 15, wherein the processing system is configured to cause the wireless communication device to:
release a connection with the UE in association with the computation capacity of the wireless communication device being insufficient for the computation service.

18. The wireless communication device of claim 15, wherein the processing system, to cause the wireless communication device to communicate the computation service management information, is configured to cause the wireless communication device to:
receive a plurality of computation service requests; and
accept a subset of the plurality of computation service requests in association with the computation capacity of the wireless communication device being insufficient for the plurality of computation service requests.

19. A method of wireless communication performed by a user equipment (UE), comprising:
transmitting, to a wireless communication device, a connection message to initiate a connection with the wireless communication device, wherein the connection is for requesting a computation service from the wireless communication device; and
communicating computation service management information with the wireless communication device, wherein the computation service management information is associated with a computation capacity of the wireless communication device.

20. The method of claim 19, wherein communicating the computation service management information comprises:
transmitting a computation service request in accordance with transmitting the connection message.
